(19) United States
(12) Patent Application Publication
(10) Pub. No.: US 2021/0278727 A1
(43) Pub. Date: Sep. 9, 2021

(54) DISPAY PANEL AND DISPLAY DEVICE

(71) Applicant: TCL China Star Optoelectronics Technology Co., Ltd., Shenzhen, Guangdong (CN)

(72) Inventors: Miao Zhou, Shenzhen, Guangdong (CN); Lixuan Chen, Shenzhen, Guangdong (CN)

(73) Assignee: TCL China Star Optoelectronics Technology Co., Ltd., Shenzhen, Guangdong (CN)

(21) Appl. No.: 16/623,790

(22) PCT Filed: Dec. 3, 2019
(86) PCT No.: PCT/CN2019/122536

§ 371 Date: Dec. 18, 2019

(51) Int. Cl. G02F 1/13357

(52) U.S. Cl. CPC G02F 1/133617; G02F 1/133606

(57) ABSTRACT

A display panel and a display device are provided. The display panel includes a first display panel, a quantum dot layer, and a second display panel. The first display panel is disposed opposite to the second display panel, and the quantum dot layer is disposed on a side of the first display panel facing the second display panel. In the above manner, through the first display panel and the second display panel provided by the present application, which enables one of the display panels to achieve dynamic backlighting, while the other display panel displays a picture, and the quantum dot layer is provided between the two display panels, so that the display panel in the present application has the characteristics of high color gamut and wide viewing angles, effectively improving the contrast of the display panel, and it can further significantly increase the transmittance of the display panel.

### FIELD OF INVENTION

The present application relates to the field of display technologies, and in particular, to a display panel and a display device.

### BACKGROUND OF INVENTION

At present, in the field of display panel technologies, the quantum dot (QD) display technology has attracted more and more attention because of its high color gamut and wide viewing angles. However, while QD display technology is widely used, it is often accompanied by the common problem of low contrast.

### Technical Problem

Therefore, in general circumstances, when using the QD display technology, a dynamic backlight technology is used, such as local dimming (partial backlight adjustment) or micro light-emitting diode (LED) to solve the problem of low contrast. However, at the same time, the technology cost of using dynamic backlight is relatively high, which makes it difficult to achieve mass production at present. Similarly, by adopting dual cell (dual display panel) display technology, that is, by stacking two liquid crystal displays (LCDs), one of the LCDs achieves dynamic backlight, and the other LCD displays the image to effectively increase the contrast of the display panel, but at the same time it will reduce the transmittance of the corresponding display panel module. Therefore, it is necessary to propose a display panel and a display device to solve the above technical problems.

### SUMMARY OF INVENTION

### Technical Solutions

The technical problem mainly solved by this application is the problem of greatly improving the transmittance of the display panel module while effectively increasing the contrast of the display panel.

In order to solve the above technical problems, the first technical solution adopted in the present application is to provide a display panel, the display panel including a first display panel, a quantum dot layer, and a second display panel;

wherein the first display panel is disposed opposite to the second display panel, and the quantum dot layer is disposed on a side of the first display panel facing the second display panel.

Meanwhile, the display panel further including a frame adhesive, wherein the frame adhesive is disposed between the quantum dot layer and a non-display region of the second display panel, and a gap layer is provided between the quantum dot layer and a display region of the second display panel.

Meanwhile, the display panel further including a water-oxygen isolation layer, wherein the water-oxygen isolation layer is disposed above the quantum dot layer and corresponding to the display region of the second display panel.

Meanwhile, the display panel further including a refractive layer, wherein the refractive layer is disposed above or below the quantum dot layer.

Meanwhile, the refractive layer is further disposed on a side of the quantum dot layer.

Meanwhile, the refractive layer is a low-refractive layer, and a refractive index of the low-refractive layer is less than refractive indices of the first display panel and the second display panel.

Meanwhile, the low-refractive layer has a refractive index equal to or larger than 1.0 and equal to or less than 1.4.

Meanwhile, the quantum dot layer includes a resin system formed by mixing red and green quantum dot materials, or a resin system formed by mixing red and green quantum dot materials and light diffusion particles, or a patterned film layer of red and green quantum dots.

Meanwhile, the display panel further includes a light diffusion particle layer, and the light diffusion particle layer is disposed above or below the quantum dot layer.

In order to solve the above technical problem, another technical solution adopted in the present application is to provide a display device, which includes the display panel as described above.

### Beneficial Effect

The beneficial effect of the present application is that, unlike the case of the conventional art, the display panel of the present application is provided with two display panels, and a quantum dot layer is further provided between the first display panel and the second display panel, so that the display panel of the present application enables one of the display panels to achieve dynamic backlighting, while the other display panel displays a picture, in addition, while realizing the characteristics of high color gamut and wide viewing angles, effectively improving the contrast of the display panel, it can further significantly increase the transmittance of the display panel.

### BRIEF DESCRIPTION OF FIGURES

The application will be further described below with reference to the accompanying drawings and embodiments. In the drawings:

FIG. 1 is a schematic structural diagram of a first embodiment of the display panel provided by the present application;

FIG. 2 is a schematic structural diagram of a second embodiment of the display panel provided by the present application;

FIG. 3 is a schematic structural diagram of a third embodiment of the display panel provided by the present application;

FIG. 4 is a schematic structural diagram of a fourth embodiment of the display panel provided by the present application;

FIG. 5 is a schematic structural diagram of a fifth embodiment of the display panel provided by the present application;

FIG. 6 is a schematic structural diagram of a sixth embodiment of the display panel provided by the present application; and

FIG. 7 is a schematic structural diagram of a seventh embodiment of the display panel provided by the present application.

### DETAILED DESCRIPTION OF EMBODIMENTS

This application is provided. In order to make the purpose, technical scheme and technical effect of this application clearer, the following further describes this application in detail. It should be understood that specific implementation embodiments described herein are only used to explain this application, and are not intended to limit this application.

Among them, by stacking two liquid crystal displays (LCDs), one of the LCDs can achieve dynamic backlighting, and the other LCD can display a picture, which can effectively improve the contrast of the display panel, but will reduce the transmittance of the corresponding display module. In order to improve the transmittance of the display panel, the technical solution adopted in the present application is to provide a quantum dot layer between two display panels to effectively improve the transmittance of the display module.

Hereinafter, it will be described in detail with reference to the drawings.

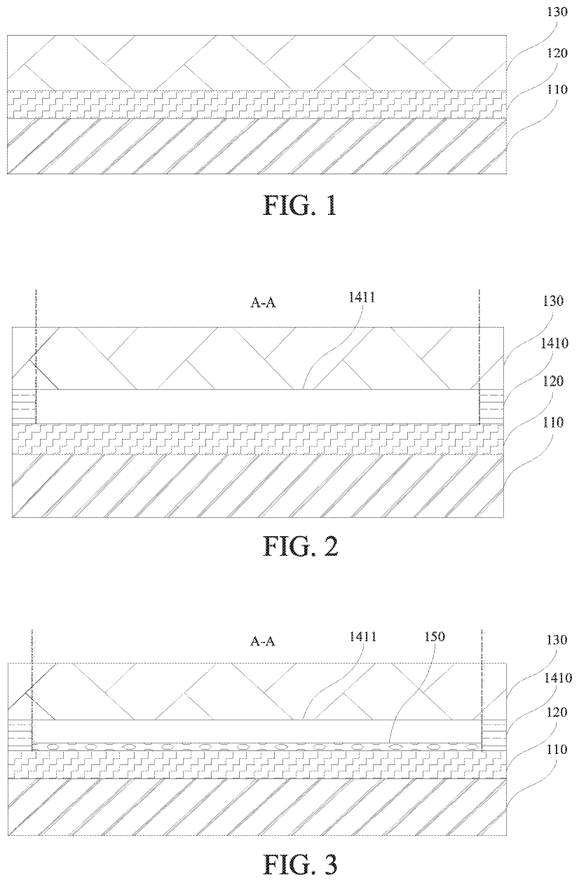

Please refer to FIG. 1, which is a schematic structural diagram of a first embodiment of a display panel provided by the present application. As shown in FIG. 1, the display panel includes a first display panel 110, a quantum dot layer 120, and a second display panel 130.

In this embodiment, the first display panel 110 is disposed opposite to the second display panel 130, and a polarizer disposed on a color filter side of the first display panel 110 is coated with a quantum dot material to form the quantum dot layer 120, and the quantum dot layer is disposed on a side of the first display panel 110 facing the second display panel 130. A structure of the quantum dot layer 120 can be a resin system formed by mixing red and green quantum dot materials, or a resin system formed by mixing red and green quantum dot materials and light diffusion particles, or it can also be a mixed resin system of quantum dots and light diffusion particles that can emit red or green light, or a patterned film layer of red and green quantum dots. For example, the red and green quantum dots are independently formed in a plane of a specific area in a predetermined pattern film layer.

Furthermore, the constituent materials of the quantum dot layer 120 specifically include a luminous core and light diffusion particles. The luminous core further includes a green luminous material and a red luminous material, and the green luminous material can be a combination of one or more of ZnCdSe2, InP, and Cd2SSe. The red luminous material can be a combination of one or more of CdSe, Cd2SeTe, and InAs. Among them, the light diffusion particles are non-luminous materials with light diffusing effect, which can be inorganic nanoparticles with a refractive index greater than 2.0, such as titanium dioxide, zirconium dioxide, etc., and a combination of one or more of II-VIA, III-VA, and II-VAQDs with a particle diameter ranging from 20 nm to 1 μm. The light diffusion particles can be mixed with the quantum dot material together to form the quantum dot layer 120, and the presence of the light diffusion particles can effectively improve the luminous efficiency of the quantum dot layer 120, thereby further improving the transmittance of the corresponding display panel. The quantum dot layer 120 can further include a common organic layer made of a resin transparent material that does not absorb light and has high transmittance, and a blue light selective reflection film material with different blue light reflectance.

Furthermore, the second display panel 130 is further disposed on the quantum dot layer 120, so that the first display panel 110 can be dynamically backlighting, and the second display panel 130 displays a picture. Therefore, while the contrast ratio of the corresponding display panel is effectively improved, the transmittance of the corresponding display panel can be greatly improved through the quantum dot layer 120.

Different from the situation of the conventional art, the display panel of the present application is provided with two display panels, and a quantum dot layer is further provided between the first display panel and the second display panel, so that the display panel of the present application enables one of the display panels to achieve dynamic backlighting, while the other display panel displays a picture, in addition, while realizing the characteristics of high color gamut and wide viewing angles, effectively improving the contrast of the display panel, and it can further significantly increase the transmittance of the display panel.

Please refer to FIG. 2, FIG. 2 is a schematic structural diagram of a second embodiment of the display panel provided by the present application. The difference between this embodiment and the first embodiment of the display panel provided by the present application in FIG. 1 is that the display panel further includes a frame adhesive 1410.

In this embodiment, the frame adhesive 1410 is disposed between the quantum dot layer 120 and an inactive display region of the second display panel 130, and a gap layer 1411 is provided between the quantum dot layer 120 and an active display region of the second display panel 140.

Meanwhile, the frame adhesive 1410 is coated and disposed on a portion of an inactive display region of the first display panel 110, that is, a portion of the periphery of an active display region of the first display panel 110 facing an inactive display region of the quantum dot layer 120. The frame adhesive 1410 can be a resin structural layer with supporting effect, and the second display panel 130 is disposed on the frame adhesive 1410, so that the quantum dot layer 120 and the second display panel 130 can be effectively bonded on the inactive display region of the second display panel 130, and in the active display region corresponding to the AA region as shown in FIG. 2, due to the supporting effect of the frame adhesive 1410 on the peripheral portion of the quantum dot layer 120, the quantum dot layer 120 faces the active display region of the second display panel 130, that is, the active display region of the second display panel 130 corresponding to the AA region is formed with the gap layer 1411. The gap layer 1411 is an air gap layer, and since air has a lower refractive index than that of the display panel, the existence of the air gap layer 1411 can further improve the transmittance of the corresponding display panel.

Meanwhile, the gap layer 1411 formed between the quantum dot layer 120 and the active display region of the second display panel 130 can be vacuum-processed in advance, so that the gap layer 1411 formed between the quantum dot layer 120 and the second display panel 130 is in a vacuum state, so as to effectively isolate the water vapor and oxygen that may occur during the manufacturing or working process of the display panel. Therefore, effectively prevent the problems of the fluorescence drop and brightness loss of the quantum dot layer 120 caused by the presence of water and oxygen, thereby effectively improving the service life of the display panel.

Please refer to FIG. 3, FIG. 3 is a schematic structural diagram of a third embodiment of the display panel provided by the present application. The difference between this embodiment and the second embodiment of the display panel provided in the present application in FIG. 2 is that the display panel further includes a water-oxygen isolation layer 150.

The water-oxygen isolation layer 150 is disposed above the quantum dot layer 120 and directly faces the active display region of the second display panel 130. The water-oxygen isolation layer 150 can be obtained by vapor deposition of the quantum dot layer 120 on an air interface facing the display region of the second display panel 130, and it can be a silicon-oxygen structure layer. In other embodiments, the water-oxygen isolation layer 150 can also be a transparent inorganic oxide composed of a combination of one or more materials of CdS, ZnSe, ZnCdS2, ZnS, and ZnO, or an inorganic protective shell layer composed of silicon nitride, aluminum oxide, and other materials, can also be other high stability composite quantum dots, such as hydrogel loaded quantum dot structure CdSe—SiO2, etc., and a material structure layer composed of perovskite quantum dots. Understandably, due to the high temperature and humidity of the display panel during the working process, and the continuous excitation of blue light, the corresponding display will be lit for a long time without any treatment to isolate water and oxygen, resulting in the loss of the brightness of the corresponding quantum dots, and eventually the failure of the quantum dots. In contrast, by attaching the water-oxygen isolation layer 150 on the quantum dot layer 120, it is possible to effectively isolate possible water vapor and oxygen, thereby avoiding the brittle surface effect caused by the presence of water and oxygen on the corresponding quantum dots, and the phenomenon that the fluorescence of the quantum dot layer 120 decreases, thereby effectively improving the service life of the corresponding display panel.

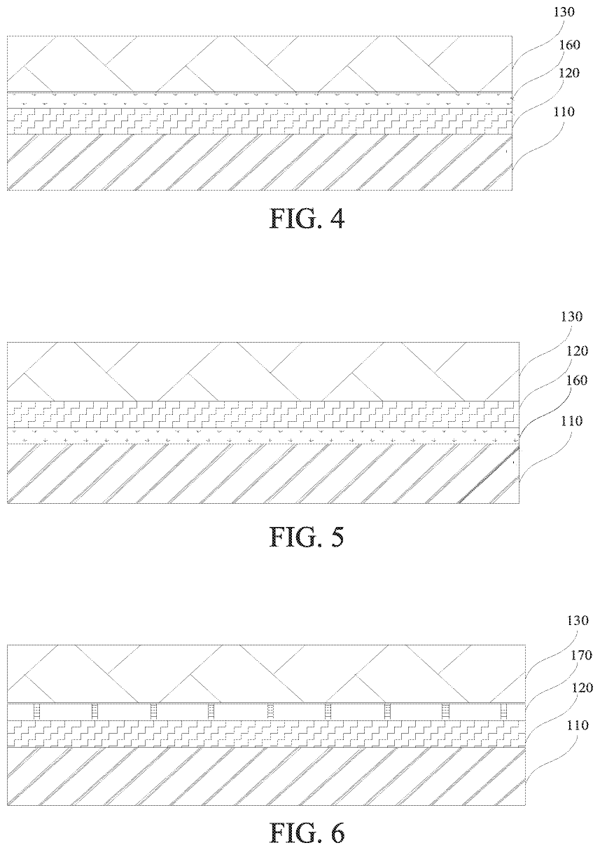

Please refer to FIGS. 4 and 5, wherein FIG. 4 is a schematic structural diagram of a fourth embodiment of the display panel provided in the present application, and FIG. 5 is a structural schematic diagram of a fifth embodiment of the display panel provided in the present application. The difference between those embodiments and the first embodiment of the display panel provided by the present application in FIG. 1 is that the display panel further includes a refractive layer 160.

The refractive layer 160 can be disposed above or below the quantum dot layer 120, as shown in FIGS. 4 and 5, respectively. The refractive layer 160 can be disposed on the quantum dot layer 120 or on the first display panel 110. In other embodiments, the refractive layer 160 can also be disposed on a side of the quantum dot layer 120 (not shown), which is not limited in this application.

Furthermore, the refractive layer 160 can be a low-refractive layer and has a refractive index less than refractive indices of the first display panel 110 and the second display panel 130. For example, the low-refractive layer can be a material layer having a refractive index equal to or greater than 1.0 and equal to or less than 1.4, which can further greatly improve the transmittance of the corresponding display panel.

Specifically, the refractive layer 160 can be a resin system having a low refractive index close to air, such as a mesoporous nanomaterial layer or a low refractive index resin film-forming structure layer, which can be understood as a simulated air gap layer, and the refractive layer 160 has a lower refractive index than the refractive indices of the first display panel 110 and the second display panel 130, so that the transmittance of the corresponding display panel can be greatly improved.

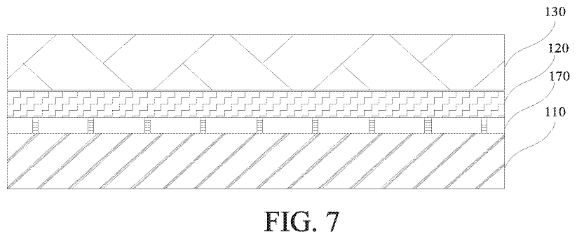

Please refer to FIGS. 6 and 7, wherein FIG. 6 is a schematic structural diagram of a sixth embodiment of the display panel provided in the present application, and FIG. 7 is a structural schematic diagram of a seventh embodiment of the display panel provided in the present application. The difference between those embodiments and the first embodiment of the display panel provided by the present application in FIG. 1 is that the display panel further includes a light diffusion particle layer 170.

Meanwhile, the light diffusion particle layer 170 is separately formed into a film to form a material layer, which is bonded and disposed on the quantum dot layer 120. In other embodiments, the light diffusion particle layer 170 can also be disposed on a surface of a side of the quantum dot layer 120 facing the first display panel 110, that is, between the first display panel 110 and the quantum dot layer 120. This application does not limit this. The arrangement of the light diffusion particle layer 170 can effectively improve the luminous efficiency of the quantum dot layer 120, thereby further improving the transmittance of the corresponding display panel.

The beneficial effect of the present application is that, unlike the case of the conventional art, the display panel of the present application is provided with two display panels, and a quantum dot layer and a low-refractive layer are further provided between the first display panel and the second display panel, so that the display panel of the present application enables one of the display panels to achieve dynamic backlighting, while the other display panel displays a picture, in addition, while realizing the characteristics of high color gamut and wide viewing angles, effectively improving the contrast of the display panel, and it can further significantly increase the transmittance of the display panel.

Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A display panel, comprising a first display panel, a quantum dot layer, and a second display panel;
wherein the first display panel is disposed opposite to the second display panel, and the quantum dot layer is disposed on a side of the first display panel facing the second display panel;
wherein the quantum dot layer comprises a resin system formed by mixing red and green quantum dot materials, or a resin system formed by mixing red and green quantum dot materials and light diffusion particles, or a patterned film layer of red and green quantum dots; and
wherein the display panel further comprises a light diffusion particle layer, and the light diffusion particle layer is disposed above or below the quantum dot layer.

2. A display panel, comprising a first display panel, a quantum dot layer, and a second display panel;
wherein the first display panel is disposed opposite to the second display panel, and the quantum dot layer is disposed on a side of the first display panel facing the second display panel.

3. The display panel according to claim 2, further comprising a frame adhesive, wherein the frame adhesive is disposed between the quantum dot layer and a non-display region of the second display panel, and a gap layer is provided between the quantum dot layer and a display region of the second display panel.

4. The display panel according to claim 3, further comprising a water-oxygen isolation layer, wherein the water-oxygen isolation layer is disposed above the quantum dot layer and corresponding to the display region of the second display panel.

5. The display panel according to claim 2, further comprising a refractive layer, wherein the refractive layer is disposed above or below the quantum dot layer.

6. The display panel according to claim 5, wherein the refractive layer is further disposed on a side of the quantum dot layer.

7. The display panel according to claim 5, wherein the refractive layer is a low-refractive layer, and a refractive index of the low-refractive layer is less than refractive indices of the first display panel and the second display panel.

8. The display panel according to claim 7, wherein the low-refractive layer has a refractive index equal to or larger than 1.0 and equal to or less than 1.4.

9. The display panel according to claim 2, wherein the quantum dot layer comprises a resin system formed by mixing red and green quantum dot materials, or a resin system formed by mixing red and green quantum dot materials and light diffusion particles, or a patterned film layer of red and green quantum dots.

10. The display panel according to claim 2, further comprising a light diffusion particle layer, wherein the light diffusion particle layer is disposed above or below the quantum dot layer.

11. A display device, comprising a display panel, wherein the display panel comprises a first display panel, a quantum dot layer, and a second display panel, wherein the first display panel and the second display panel are disposed opposite to each other, and the quantum dot layer is disposed on a side of the first display panel facing the second display panel.

12. The display device according to claim 11, wherein the display panel further comprises a frame adhesive, wherein the frame adhesive is disposed between the quantum dot layer and a non-display region of the second display panel, and a gap layer is provided between the quantum dot layer and the display region of the second display panel.

13. The display device according to claim 12, wherein the display panel further comprises a water-oxygen isolation layer, wherein the water-oxygen isolation layer is disposed above the quantum dot layer and corresponding to a display region of the second display panel.

14. The display device according to claim 11, wherein the display panel further comprises a refractive layer, wherein the refractive layer is disposed above or below the quantum dot layer.

15. The display device according to claim 14, wherein the refractive layer is further provided on a side of the quantum dot layer.

16. The display device according to claim 14, wherein the refractive layer is a low-refractive layer, and a refractive index of the low-refractive layer is less than refractive indices of the first display panel and the second display panel.

17. The display device according to claim 16, wherein the low-refractive layer has a refractive index equal to or larger than 1.0 and equal to or less than 1.4.

18. The display device according to claim 11, wherein the quantum dot layer comprises a resin system formed by mixing red and green quantum dot materials, or a resin system formed by mixing red and green quantum dot materials and light diffusion particles, or a patterned film layer of red and green quantum dots.

19. The display device according to claim 11, wherein the display panel further comprises a light diffusion particle layer, and the light diffusion particle layer is disposed above or below the quantum dot layer.
